(19) United States
(12) Patent Application Publication
(10) Pub. No.: US 2015/0220037 A1
(43) Pub. Date: Aug. 6, 2015

(54) IMAGE FORMING APPARATUS

(71) Applicant: BROTHER KOGYO KABUSHIKI KAISHA, Nagoya (JP)

(72) Inventor: Hirotaka MORI, Nagoya (JP)

(21) Appl. No.: 14/608,525

(22) Filed: Jan. 29, 2015

(30) Foreign Application Priority Data
Jan. 31, 2014 (JP) 2014-017309

(51) Int. Cl. G03G 15/00

(52) U.S. Cl. CPC G03G 15/6529

(57) ABSTRACT

An image forming apparatus, including a conveyer, an image forming unit, and a guide member to guide a sheet, is provided. The conveyer includes a first roller, a second roller, and a belt strained around the first and second rollers and including a first surface to contact the sheet. The image forming unit forms an image on the sheet in an image forming area, which includes at least a part of an overlapping area coincident with the belt and at least a part of a displaced area being displaced from the belt along a direction of rotation axis of the rollers. The guide member is arranged in a position displaced from the belt along the direction of rotation axis and at least in a position displaced from the image forming area along a direction of conveyance to convey the sheet by the conveyer.

### CROSS REFERENCE TO RELATED APPLICATION

This application claims priority from Japanese Patent Application No. 2014-017309, filed on Jan. 31, 2014, the entire subject matter of which is incorporated herein by reference.

### BACKGROUND

1. Technical Field

An aspect of the present disclosure relates to a technique to convey a sheet by rolling a belt in an image forming apparatus.

2. Related Art

An image forming apparatus, in which a belt is rolled to convey a sheet, and an image is formed on the sheet being conveyed, is known. The belt in the image forming apparatus may be strained around two (2) or more rollers so that the sheet is conveyed on the belt as the rollers rotate and an image is formed on the sheet being conveyed. In order to reduce a manufacturing cost for the image forming apparatus, the belt may be designed to have a width, which is a dimension along rotation axes of the rollers, to be smaller than a width of a photo-exposable area of a photosensitive drum.

### SUMMARY

Thus, if the photo-exposable area of the photosensitive drum is wider than the width of the belt, a sheet having a width, which is as wide as the photo-exposable area of the photosensitive drum and is wider than the width of the belt, may be used to form an image thereon. In this regard, however, a part of the sheet which extends beyond the width of the belt may not be supported by the belt. Therefore, the sheet may not be stabilized at the non-supported part with regard to a direction orthogonal to a belt surface, and the sheet may be conveyed in an unstable condition to the photosensitive drum in an image forming unit.

The present disclosure is advantageous in that a technique to restrain unstable conveyance of a sheet in an image forming apparatus is provided.

According to an aspect of the present disclosure, an image forming apparatus, including a conveyer, an image forming unit, and a guide member, is provided. The conveyer is configured to convey a sheet and includes a first roller, a second roller, and a belt. The belt is strained around the first roller and the second roller and includes a first surface configured to contact the sheet. The image forming unit is configured to form an image on the sheet being conveyed in an image forming area. The image forming area includes at least a part of an overlapping area and at least a part of a displaced area. The overlapping area is coincident with the belt, and the displaced area is displaced from the belt along a direction of rotation axis of the first roller. The guide member is configured to guide a surface of the sheet. The guide member is arranged in a position displaced from the belt along the direction of rotation axis and at least in a position displaced from the image forming area along a direction of conveyance to convey the sheet by the conveyer.

### BRIEF DESCRIPTION OF THE ACCOMPANYING DRAWINGS

FIG. 1 is an illustrative view of a mechanical configuration of a printer according to an exemplary embodiment of the present disclosure.

FIG. 2 is a block diagram to illustrate electrical configuration of the printer according to the exemplary embodiment of the present disclosure.

FIG. 3 is a perspective view of a belt unit of the printer according to the exemplary embodiment of the present disclosure.

FIG. 4 is a cross-sectional partial view of the belt unit of the printer, taken along a direction of conveyance to convey a sheet in the printer, according to the exemplary embodiment of the present disclosure.

FIG. 5 is an illustrative view of a mechanical configuration of the printer according to an exemplary embodiment of the present disclosure.

FIG. 6 is a top plan view of the belt unit of the printer according to the exemplary embodiment of the present disclosure.

FIG. 7 is a cross-sectional partial view of the belt unit of the printer, taken along the direction of conveyance, according to the exemplary embodiment of the present disclosure

FIG. 8 is a cross-sectional partial view of the belt unit of the printer, taken along the direction of conveyance, according to the exemplary embodiment of the present disclosure.

FIG. 9 is a cross-sectional partial view of the belt unit of the printer, taken along a direction of rotation axis, according to an exemplary embodiment of the present disclosure.

### DETAILED DESCRIPTION

Hereinafter, a printer 1 as an exemplary embodiment of the present disclosure will be described with reference to the accompanying drawings. It is noted that various connections are set forth between elements in the following description. These connections in general, and unless specified otherwise, may be direct or indirect, and this specification is not intended to be limiting in this respect.

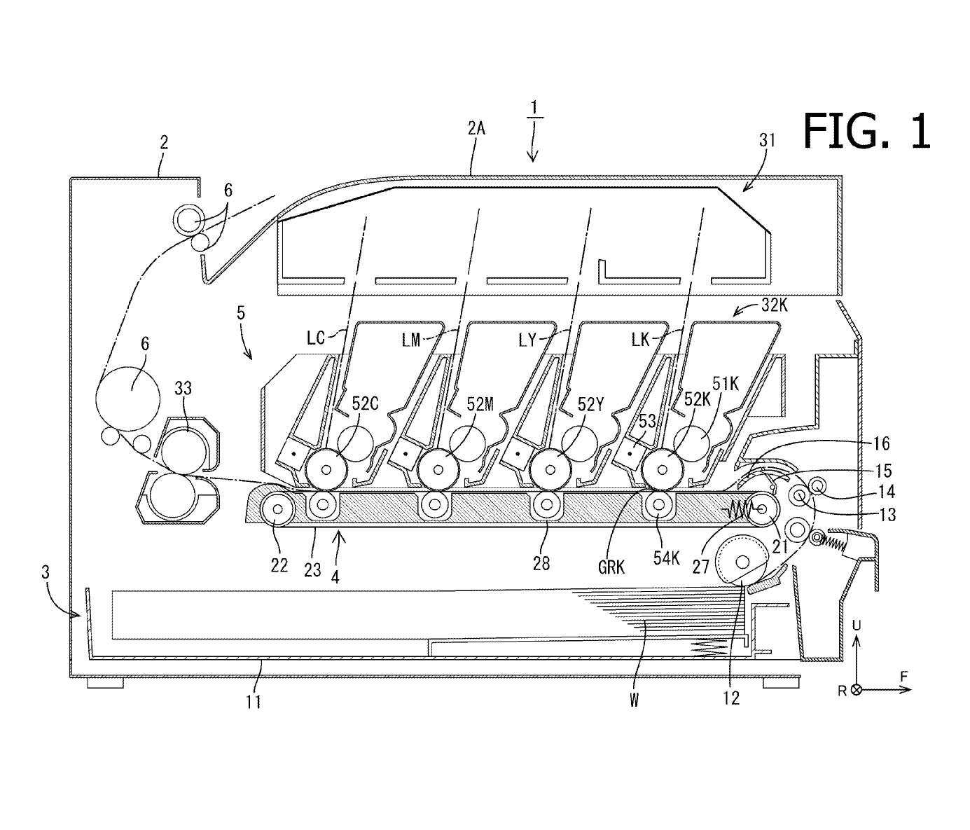

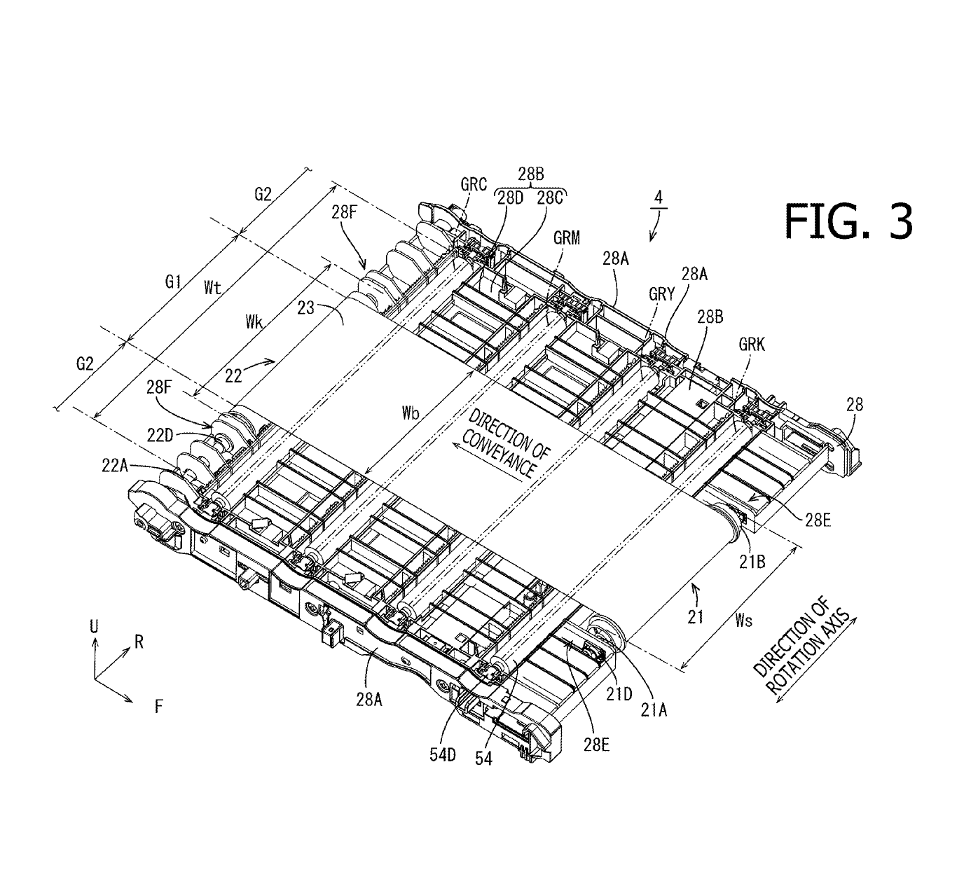

The printer 1 is a direct-transferring tandem-typed color laser printer capable of forming images in a plurality of (e.g., four) colors, which are, for example, black (K), yellow (Y), magenta (M), and cyan (C). In the following description, directions concerning the printer 1 and each part or component included in the printer 1 will be referred to based on orientations indicated by arrows shown in each drawing. For example, a viewer's right-hand side in FIG. 1 is defined as a front side F, and a left-hand side is defined as rear. A viewer's farther side in FIG. 1 is defined as a right-hand side R of the printer 1, and a nearer side is defined as a left-hand side. An upper side in FIG. 1 corresponds to an upper side U of the printer 1 according to a direction of gravity. A right-to-left or left-to-right direction of the printer 1 may also be referred to as a right-left direction or a widthwise direction. An up-to-down or down-to-up direction with regard to the direction of gravity may also be referred to as a vertical direction. A front-to-rear or rear-to-front direction may be referred to as a front-rear direction or a direction of depth. Furthermore, directions of the drawings in FIGS. 3-9 are similarly based on the orientation of the printer 1 as defined above and correspond to those with respect to the printer 1 shown in FIG. 1 even when the printer 1 in the drawings is viewed from different angles. However, the orientations concerning the printer 1 may not necessarily be limited to those described below or indicated in the accompanying drawings. Further, it is noted that a quantity of each of the components and elements denoted by reference signs is, unless otherwise noted, at least one.

In the printer 1 according to the present disclosure, there may be a plurality of parts or components which are in an identical configuration for forming images in the plurality of colors K, Y, M, C. Those identically-configured parts or components may be indicated by the same reference signs except for letters (K, Y, M, C) at the ends thereof, which indicate the different colors. Meanwhile, the reference signs without the letters (K, Y, M, C) at the ends may be used to represent the plurality of identically-configured parts or components. In the accompanying drawings, reference signs for some of the parts or components in the identical configuration may be omitted.

The printer 1 includes a main casing 2, a sheet feeder unit 3, a belt unit 4, an image forming unit 5, and ejection rollers 6.

The sheet feeder unit 3 includes a feeder tray 11, a pickup roller 12, a registration roller 13, a pinch roller 14, a sheet guide 16, and a sheet sensor 15. The pickup roller 12 forwards sheets W stored in the feeder tray 11 one-by-one to the registration roller 13 and the pinch roller 14.

The registration roller 13 rotates to convey the sheet W to the belt unit 4, which will be described later in detail. The pinch roller 14 is rotated according to the rotation of the registration roller 13 and conveys the sheet W in conjunction with the registration roller 13. The sheet guide 16 is arranged to contact the sheet W being conveyed by the registration roller 13 and the pinch roller 14 and guide the sheet W to the belt unit 4.

The sheet sensor 15 is arranged to detect presence of the sheet W in a detectable area, which is between the registration roller 13 and the belt unit 4, and outputs signals according to detected presence or absence of the sheet W in the detectable area. Based on the signals, which indicate detection of a leading edge of the sheet W in the detectable area, from the sheet sensor 15, a timing to form an image on the sheet W is determined.

The belt unit 4 includes a support roller 21, a driving roller 22, a belt 23 being an endless belt, and a resilient member 27, which are supported by a frame 28. The belt 23 is strained around the support roller 21 and the driving roller 22 to spread along a horizontal direction. The belt 23 is rolled to circulate in a counterclockwise direction in FIG. 1 to convey the sheet W being contacted with an upper outer surface of the belt 23 toward the rear side.

The resilient member 27 is arranged to urge the support roller 21 in a direction to be away from the driving roller 22. Thus, the support roller 21 serves to apply tensile force to the belt 23 so that the belt 23 is restricted from loosening between the driving roller 22 and the support roller 21. On an inner side of the belt 23, arranged are transfer rollers 54. The transfer roller 54 includes a transfer roller 54K for black, a transfer roller 54Y for yellow, a transfer roller 54M for magenta, and a transfer roller 54C for cyan.

The image forming unit 5 includes a scanner unit 31, processing units 32K, 32Y, 32M, 32C, and a fixing unit 33.

The scanner unit 31 emits laser beams LK, LY, LM, LC according to image data for the four colors onto surfaces of photosensitive drums 52K, 52Y, 52M, 52C, which are arranged outside of the belt 23. Thus, the surfaces of the photosensitive drums 52K, 52Y, 52M, 52C are selectively exposed to the laser beams LK, LY, LM, LC respectively.

The processing unit 32K is for forming an image in black and includes a developer roller 51K, a photosensitive drum 52K, a charger 53, and the transfer roller 54K. The developer roller 51K, the photosensitive drum 52K, and the charger 53 are arranged outside of the belt 23, and the transfer roller 54K is arranged on the inner side of the belt 23. The developer roller 51K supplies a black toner to the photosensitive drum 52K.

The surface of the photosensitive drum 52K is electrically charged evenly by the charger 53, and the charged surface of the photosensitive drum 52K is selectively exposed to the laser beam LK from the scanner unit 31. Thus, the exposed area forms an electrostatic latent image. Thereafter, the toner is supplied to the electrostatic latent image by the developer roller 51K so that a toner image in black is developed on the photosensitive drum 52K.

The toner image developed on the photosensitive drum 52K is transferred by static electricity in the transfer roller 54K onto the sheet W being conveyed on the belt 23. Thus, the image is formed in the black toner on the sheet W. In the following description, an area, in which the toner image can be transferred to the sheet W, will be referred to as an image forming area GR. The image forming area GR include an image forming area GRK for black, an image forming area GRY for yellow, an image forming area GRM for magenta, and an image forming area GRC for yellow (see FIG. 3). In this regard, the processing units 32Y, 32M, 32C for yellow, magenta, cyan are in the similar configuration as the processing unit 32K for black; therefore, description of those are herein omitted.

The fixing unit 33 thermally fixes the toner image transferred onto the sheet W thereat. The sheet W conveyed through the fixing unit 33 is conveyed upward by the ejection rollers 6 and ejected on an ejection tray 2A, which is arranged at a top of the main casing 2.

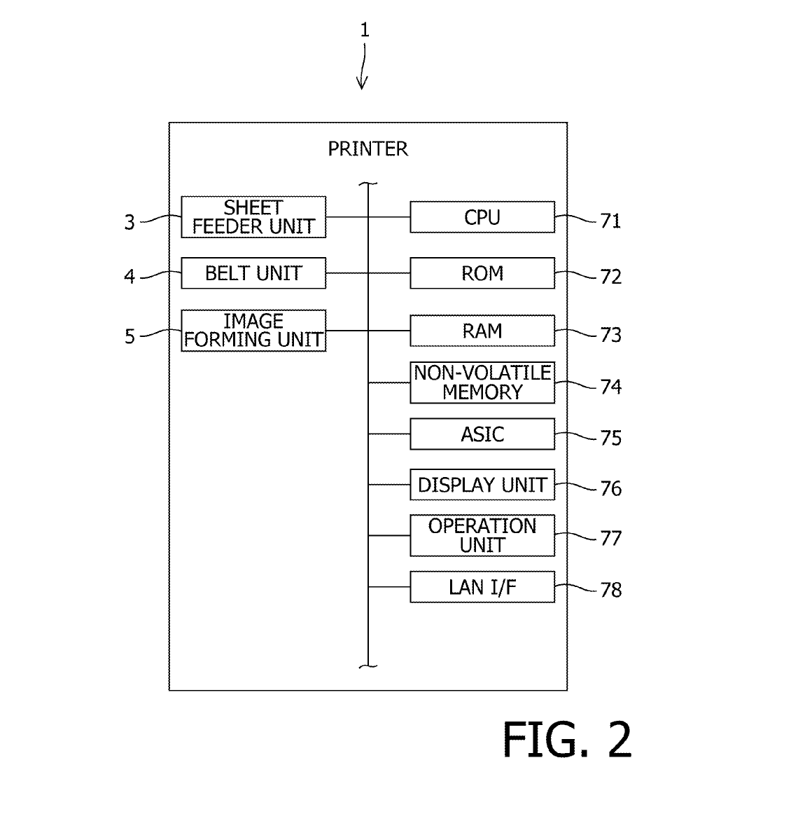

Further to the sheet feeder unit 3, the belt unit 4 and the image forming unit 5 described above, the printer 1 includes, as shown in FIG. 2, a central processing unit (CPU) 71, a read-only memory (ROM) 72, a random access memory (RAM) 73, a non-volatile memory 74, an application specific integrated circuit (ASIC) 75, a display unit 76, an operation unit 77, and a network interface 78.

The ROM 72 stores a various types of programs including a program to control rotation of rollers such as the driving roller 22 in the belt unit 4 and the registration roller 13. The RAM 73 and the non-volatile memory 74 provide work areas for the programs when the programs are running and temporary storages for data being used in the programs. The non-volatile memory 74 may be a writable memory device including an NVRAM, a flash memory, an HDD, an EEPROM.

The CPU 71 is connected with various components in the printer 1, including the ROM 72 and the RAM 73, and controls the components according to the programs read from the ROM 72. The display unit 76 includes a liquid crystal display and lamps (not shown) and is capable of displaying information concerning settings, behaviors of the printer 1, and processes executed in the printer 1, through various forms of screens. The operation unit 77 includes a plurality of buttons (not shown) and is capable of receiving various types of inputs and instructions from a user. The network interface 78 is an interface, through which communication between the printer 1 and an external device (not shown) is exchanged in wireless or wired communication.

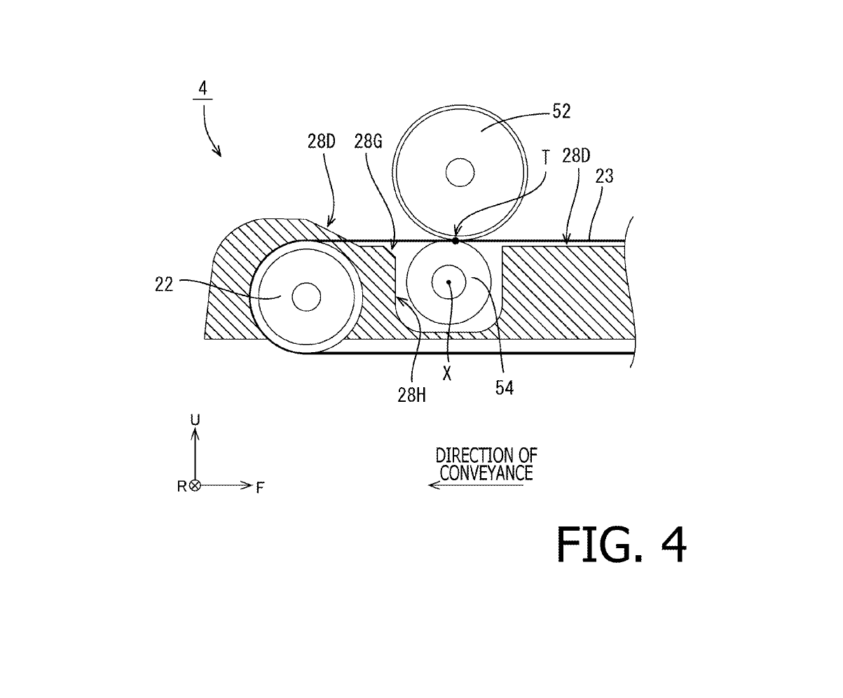

Next, with reference to FIGS. 3 and 4, a detailed configuration of the belt unit 4 is described below. The frame 28 of the belt unit 4 supports bearings 21D, 22D, 54D of the support roller 21, the driving roller 22, and the transfer rollers 54 respectively; thereby, the support roller 21, the driving roller 22, and the transfer rollers 54 are supported in an arrangement such that directions of rotation axes thereof are in parallel with one another, and the support roller 21, the driving roller 22, and the transfer rollers 54 are restricted from moving with respect to one another. In the following description, a direction in parallel with the rotation axes of the support roller 21, the driving roller 22, and the transfer rollers 54 will be referred to as a direction of rotation axis.

A width Wb, which is a dimension of the belt 23 along the direction of rotation axis, is smaller than a width Wt of the transfer rollers 54 along the direction of rotation axis. In this regard, a maximum allowable dimension of the image forming area GR along the direction of rotation axis in each of the processing units 32K-32C is limited by the width Wt of the transfer rollers 54 along the direction of rotation axis. In other words, the width Wb of the belt 23 along the direction of rotation axis is set to be smaller than the dimension of the image forming area GR along the direction of rotation axis.

Therefore, each transfer roller 54 is in an arrangement with regard to the direction of rotation axis such that a part of the transfer roller 54 is in an overlapping area G1, in which the transfer roller 54 coincides with the upper outer surface of the belt 23 along the direction of rotation axis, and a remainder part of the transfer roller 54 is in an exposed area G2, in which the transfer roller 54 is displaced from the upper outer surface of the belt 23 along the direction of rotation axis. In this regard, the arrangement that the transfer roller 54 coincides with the belt 23 along the direction of rotation axis refers to a condition that the transfer roller 54 and the belt 23 fall on a same area with regard to the direction of rotation axis. In other words, the transfer roller 54 overlaps the belt 23 in a view along a direction orthogonal to the direction of rotation axis, which is, according to the exemplary embodiment, the direction of gravity. Meanwhile, the arrangement that the transfer roller 54 is displaced from the belt 23 refers to a condition that the transfer roller 54 and the belt 23 do not overlap each other in a view along the direction orthogonal to the direction of rotation axis.

The transfer rollers 54K-54C are opposed to the photosensitive drums 52K-52C respectively, across the belt 23 in the overlapping area G1, and directly in the exposed area G2. In other words, in the overlapping area G1, the belt 23 contacts the photosensitive drums 52K-52C, while in the exposed area G2 the transfer rollers 54K-54C contact the photosensitive drums 52K-52C respectively.

In the exemplary embodiment, the belt 23 and the transfer rollers 54 are in an arrangement such that a center of the belt 23 along the direction of rotation axis is aligned with centers of the transfer rollers 54 along the direction of rotation axis. Therefore, at each side of the belt 23 along the direction of rotation axis, the exposed area G2 exists. In other words, two (2) exposed areas G2 are arranged on outer sides of the overlapping area G1 along the direction of rotation axis.

The support roller 21 is formed in a hollow cylindrical shape and has spokes (unsigned) expanding in radial directions at axial ends thereof. The support roller 21 is held via the spokes in a position to be centered at a rotation shaft 21A. In this regard, the support roller 21 is formed separately from the rotation shaft 21A and rotates idly with respect to the rotation shaft 21A.

The driving roller 22 is formed in a hollow cylindrical shape and has spokes (not shown) expanding in radial directions at axial ends thereof. The driving roller 22 is held via the spokes in a position to be centered about a rotation shaft 22A. In this regard, the driving roller 22 is fixed to the rotation shaft 22 A and rotates integrally with the rotation shaft 22A.

The driving roller 22 is rotated by a driving force from a motor (not shown), which is activated by an instruction from the CPU 71, and applies a circulating force to the belt 23. The support roller 21 is arranged on an upstream side of the driving roller 22 with regard to a direction of conveyance to convey the sheet W and is rotated by the circulation of the belt 23.

While the belt 23 is strained around the support roller 21 and the driving roller 22, a dimension Ws of the support roller 21 and a dimension Wk of the driving roller 22 along the direction of rotation axis should at least as large as or substantially larger than the width Wb of the belt 23 along the direction of rotation axis. While the width Wb of the belt 23 along the direction of rotation axis is smaller than the width Wt of the transfer rollers 54, therefore, the dimensions Ws, Wk of the support roller 21 and the driving roller 22 are smaller than the dimension Wt of the transfer rollers 54 along the direction of rotation axis and substantially larger than the width Wb of the belt 23 along the direction of rotation axis.

The support roller 21 is provided with a pair of flange parts 21B. Each of the flange parts 21B is formed to spread outwardly with respect to a part of the support roller 21 which contacts the belt 23 along a radial direction. The flange part 21B is arranged in each exposed area G2, which is on an outer side of the belt 23 along the direction of rotation axis. The flange parts 21B are arranged to face with cross-sectional edges of the belt 23, which are at widthwise ends along the direction of rotation axis, and restrict the belt 23 from moving in the direction of rotation axis.

The flange part 21B is arranged to protrude outwardly in the radial direction of the support roller 21 from the upper outer surface of the belt 23. In the exemplary embodiment, as shown in FIG. 1, the sheet guide 16, which forms a part of a conveying path to convey the sheet W therein toward the belt 23, is arranged on a downstream side of the support roller 21 with regard to the direction of conveyance to face with the belt 23 at a position on an upstream side of the image forming area GR with regard to the direction of conveyance. Therefore, while the flange part 21B protrudes from the upper outer surface of the belt 23, the sheet W having been conveyed to the belt 23 may be prevented from contacting the protruding flange part 21B and from being skewed with respect to the direction of conveyance by the contact.

The frame 28 includes a pair of main parts 28A, which extend along the direction of conveyance and support the bearings 54D, and intermediate parts 28B, which connect the paired main parts 28A with each other along the direction of rotation axis. Each intermediate part 28B is arranged at a bottom of the frame 23 and includes a base plane 28C, which is arranged to spread in parallel with the belt 23, and ribs 28D, which protrude from the base plane 28C toward the belt 23, i.e., upward with regard to the direction of gravity. The ribs 28D longitudinally extend in parallel with the direction of conveyance, and when a part of the sheet W in the exposed area G2 tends to shift closer to the base plane 28C, the ribs 28D contact a lower surface of the sheet W to guide the sheet W. Thus, when, for example, the sheet W tends to drop downward with regard to the direction of gravity by its own weight and deforms, a movable range for the sheet W with regard to the direction of gravity may be restricted by the ribs 28D.

The ribs 28D are arranged in positions displaced from the transfer rollers 54 along the direction of conveyance. In particular, the ribs 28D are arranged on an upstream side of the transfer rollers 54 along the direction of conveyance and guide the sheet W to be conveyed to the image forming areas GR. Some of the ribs 28D on the upstream side of the transfer rollers 54 provide supporting parts 28E, which support the bearings 21D at inner positions closer to the belt 23D with regard to the direction of rotation axis than axial ends of the transfer rollers 54.

In the meantime, there are ribs 28D that are arranged on a downstream side of the transfer rollers 54 along the direction of conveyance to guide the sheet W having been conveyed through the image forming areas GR. Some of the ribs 28D on the downstream side of the transfer rollers 54 provide supporting parts 28F, which support the bearings 22D at inner positions closer to the belt 23D with regard to the direction of rotation axis than the axial ends of the transfer rollers 54. Further, there are ribs 28D that are arranged in positions between the transfer rollers 54 along the direction of conveyance to guide the sheet W conveyed through one of the image forming areas GR to another one of the image forming areas GR.

As shown in FIG. 4, the ribs 28D are arranged on a lower side of the belt 23 with regard to the direction of gravity. Upper edges of the ribs 28D are arranged in positions substantially same as or lower than a contact position T between the photosensitive drums 52 and the transfer rollers 54. In other words, the upper edges of the ribs 28D are in positions on the same side as the transfer rollers 54 with respect to the contact position along the direction of gravity and are farther from the photosensitive drums 52 than the contact position T. Further, at the same time, the upper edges of the ribs 28D are in higher positions than rotation axes X of the transfer rollers 54 with regard to the direction of gravity.

The ribs 28D arranged on the downstream side of each transfer roller 54 are formed to have a beveled edge 28G, which helps the sheet W to be smoothly conveyed out of the image forming area GR. The beveled edge 28G is formed in an adjoining part 28H, which adjoins the transfer roller 54, in each of the ribs 28D, and inclines to shift closer to the belt 23 as the beveled edge 28G extends to distance away from the transfer roller 54 toward the downstream along the direction of conveyance. Therefore, even when the sheet W being conveyed by the transfer roller 54 through the image forming area GR tends to be shifted downward with regard to the direction of gravity, the sheet W may be conveyed smoothly along the beveled edge 28G.

Meanwhile, the ribs 28D arranged on the downstream side of one of the transfer rollers 54, which is at a most downstream position along the direction of conveyance, have a form to separate the sheet W from the belt 23. In particular, upper edges of those ribs 28D are formed to incline to protrude upward from the upper outer surface of the belt 23 as the ribs 28D extend to distance away from the transfer roller 54 toward the downstream along the direction of conveyance. In other words, the upper edges of the ribs 28D incline from positions lower than the belt 23 to be higher than the belt 23 with regard to the direction of gravity as the ribs 28D extend farther away from the transfer roller 54 toward the downstream along the direction of conveyance. Therefore, the sheet W conveyed by the belt 23 to a position to contact the ribs 28D is separated from the belt 23 by the protrusive portions of the ribs 28D protruded from the upper outer surface of the belt 23.

Thus, according to the exemplary embodiment described above, the frame 23 is provided with the ribs 28D in the exposed areas G2. The ribs 28D are arranged in the positions displaced from the transfer rollers 54 along the direction of conveyance and guide the surface of the sheet W. Therefore, compared to the conventional configuration, which is not provided with the ribs 28D, the position of the sheet W with regard to the direction of orthogonal to the surface of the sheet W, i.e., with regard to the direction of gravity, may be restricted. Accordingly, unstable conveyance of the sheet W may be restrained.

According to the exemplary embodiment described above, the ribs 28D extending along the direction of conveyance provide the guiding structure to guide the surface of the sheet W. Therefore, compared to a configuration, in which the sheet W may be guided along, for example, a plane surface, or compared to a configuration, in which the ribs to guide the surface of the sheet W do not extend along the direction of conveyance, conveying resistance to convey the sheet W may be reduced.

According to the exemplary embodiment described above, the frame 28 includes the intermediate parts 28B, which includes the base plane 28C spreading in parallel with the belt 23. And the ribs 28D are formed to protrude upward with regard to the direction of gravity from the base plane 28C. Therefore, compared to a configuration without the base plane 28C, rigidity of the frame 28 may be improved.

According to the exemplary embodiment described above, the ribs 28D are arranged on the lower side of the belt 23 with regard to the direction of gravity; therefore, the sheet W is restricted from dropping downward with regard to the direction of gravity while being conveyed. In particular, the upper edges of the ribs 28D to guide the sheet W are in the lower position than the contact position T between the photosensitive drum 52 and the transfer roller 54, and in the upper position than the rotation axis X of the transfer roller 54 with regard to the direction of gravity. Therefore, the position of the sheet W to be shifted is restricted within a range smaller than a radius of the transfer roller 54. Accordingly, unstable conveyance of the sheet W may be restrained.

According to the exemplary embodiment described above, some of the ribs 28D arranged on the upstream side of the transfer rollers 54 along the direction of conveyance guide the sheet W to be conveyed to the image forming area GR. Therefore, the sheet W may be conveyed to the image forming area GR stably.

According to the exemplary embodiment described above, some of the ribs 28D arranged on the downstream side of the transfer rollers 54 along the direction of conveyance guide the sheet W having been conveyed through the image forming area GR. Therefore, the sheet W may be conveyed through the image forming area GR stably.

According to the exemplary embodiment described above, some of the ribs 28D arranged in the intervening positions between the transfer rollers 54 along the direction of conveyance guide the sheet W conveyed through one of the image forming areas GR to the next image forming area GR. Therefore, the sheet W may be conveyed stably in the intervening areas between the image forming areas GR. Further, with the ribs 28D in the intervening areas between the transfer rollers 54, rigidity of the frame 28 may be improved.

According to the exemplary embodiment described above, the ribs 28D on the downstream side of the transfer rollers 54 are formed to have the beveled edges 28G; therefore, the sheet W conveyed through the image forming areas GR may be conveyed smoothly along the ribs 28D.

According to the exemplary embodiment described above, the ribs 28D on the downstream side of the transfer rollers 54 along the direction of conveyance are arranged to locate the upper edges thereof to incline upward with regard to the direction of gravity as the ribs 28D extend away from the transfer roller 54 toward the downstream along the direction of conveyance. Therefore, the sheet W passing through the image forming area GR may be separated by the ribs 28D from the belt 23.

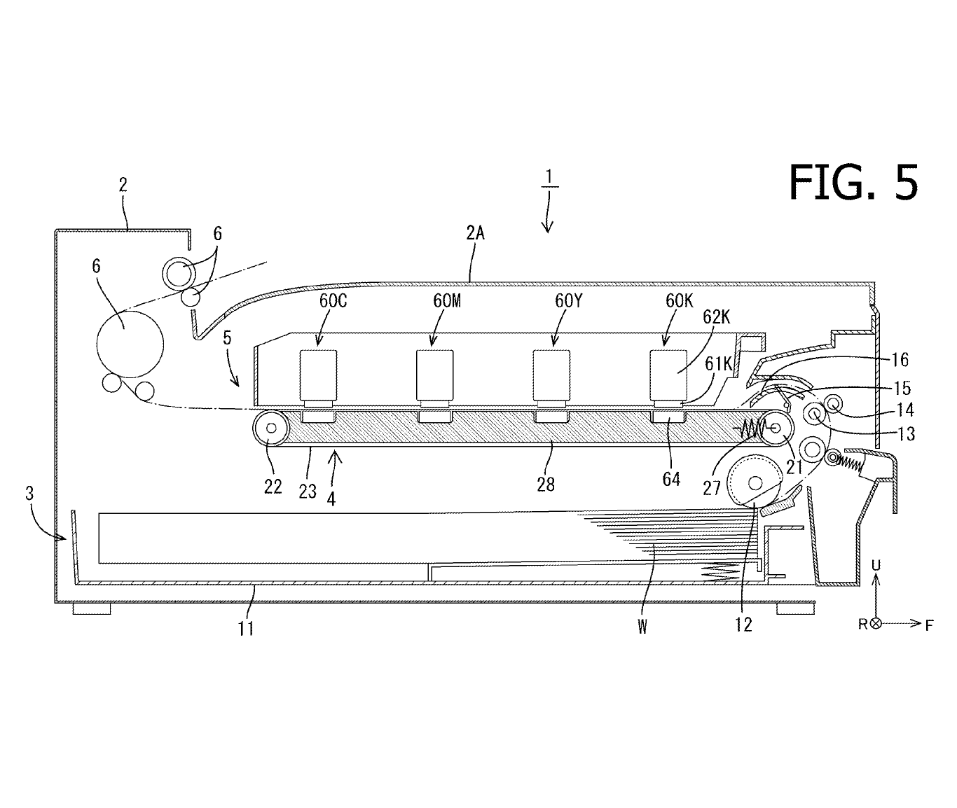

Next, the printer 1 according to another exemplary embodiment will be described with reference to FIGS. 5-7. In the present exemplary embodiment, the printer 1 is an inkjet printer, which is different from the printer in the previous exemplary embodiment in that an image is formed in inks in a plurality of (e.g., four) colors (e.g., black, yellow, magenta, and cyan). In the following description, items or structures which are the same as or similar to the items or the structures described in the previous exemplary embodiment will be referred to by the same reference signs, and description of those will be omitted.

As shown in FIG. 5, the image forming unit 5 includes inkjet heads 60K, 60Y, 60M, 60C. An inkjet head 60K for forming an image in black includes a head portion 61K and an ink cartridge 62K and is arranged outside of the belt 23. The ink cartridge 62K supplies ink in black to the head portion 61K.

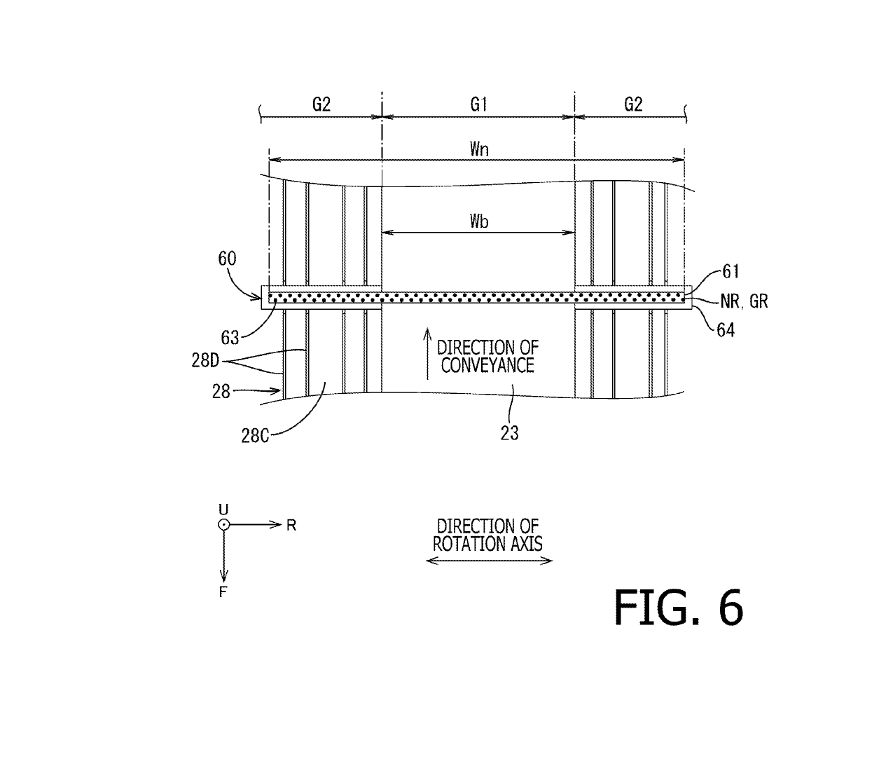

On a bottom of the head portion 61K, a plurality of finely-formed nozzles 63 are arranged (see FIG. 6). Among the plurality of nozzles 63, the head portion 61K selectively discharges the ink in black from the nozzles 63 based on the image data for black toward the sheet W being conveyed on the belt 23. Thus, the image in black is formed on the sheet W. In the exemplary embodiment, an area, to which the ink can be ejected, will be referred to as an image forming area GR. The inkjet heads 60Y, 60M, 60C are configured identically to the inkjet head 60K except for the colors of the ink to be used therewith, and description of those will be omitted. In the following description, an inkjet head 60 may represent any one or more of the inkjet heads 60K, 60Y, 60M, 60C.

As shown in FIG. 6, the inkjet head 60 is a line-typed inkjet head, in which the plurality of nozzles 63 are arranged in a nozzle area NR on the bottom of the head portion 61 to align along the direction of rotation axis. A dimension Wn of the nozzle area NR along a longitudinal direction limits a maximum allowable dimension of the image forming area GR for the inkjet heads 60K-60C along the direction of rotation axis. In other words, the nozzles 63 are arranged in an entire range along the direction of rotation axis in the image forming area GR. The dimension of the image forming area GR for the inkjet heads 60K-60C along the direction of rotation axis will be referred to as a dimension of the image forming area GR along the direction of rotation axis.

A width Wb of the belt 23 along the direction of rotation axis is set to be smaller than the dimension Wn of the nozzle area NR along the direction of rotation axis, i.e., the dimension of the image forming area GR along the direction of rotation axis. Therefore, the head portion 61 is in an arrangement with regard to the direction of rotation axis such that a part of the head portion 61 is in an overlapping area G1, in which the head portion 61 overlaps the upper outer surface of the belt 23, and a remainder part of the head portion 61 is in an exposed area G2, in which the head portion 61 is displaced from the upper outer surface of the belt 23.

In a position to oppose to the inkjet head 60, arranged is an ink absorber 64 made of, for example, non-woven fabric. More specifically, the ink absorber 64 is arranged on a lower side of the upper outer surface of the belt 23 with regard to the direction of gravity, on an inner side of the belt 23 (see FIG. 5). In the meantime, the ink absorber 64 is arranged in a position to overlap the head portion 61 along the direction of gravity (see FIG. 6). Therefore, the head portion 61 is opposed to the ink absorber 64 across the belt 23 in the overlapping area G1, and directly in the exposed area G2. The ink absorber 64 absorbs the ink, which was discharged from the nozzles 63 of the head portion 61 but did not land on the sheet W or the belt 23.

The frame 28 includes the ribs 28D, which guide the lower surface of the sheet W when the sheet W tends to drop downward with regard to the direction of gravity and deform in the exposed area G2. The ribs 28D are arranged in positions displaced from the head portion 61 along the direction of conveyance. In this regard, the arrangement that the ribs 28D are displaced from the head portion 61 along the direction of conveyance refers to a condition that the ribs 28D and the head portion 61 do not fall on a same area with regard to the direction of conveyance. In other words, the ribs 28 and the head portion 61 do not overlap each other in a view along the direction orthogonal to the direction of rotation axes, which is, according to the exemplary embodiment, the direction of gravity. Upper edges of the ribs 28D are in positions substantially same as or lower than the upper outer surface of the belt 23 with regard to the direction of gravity.

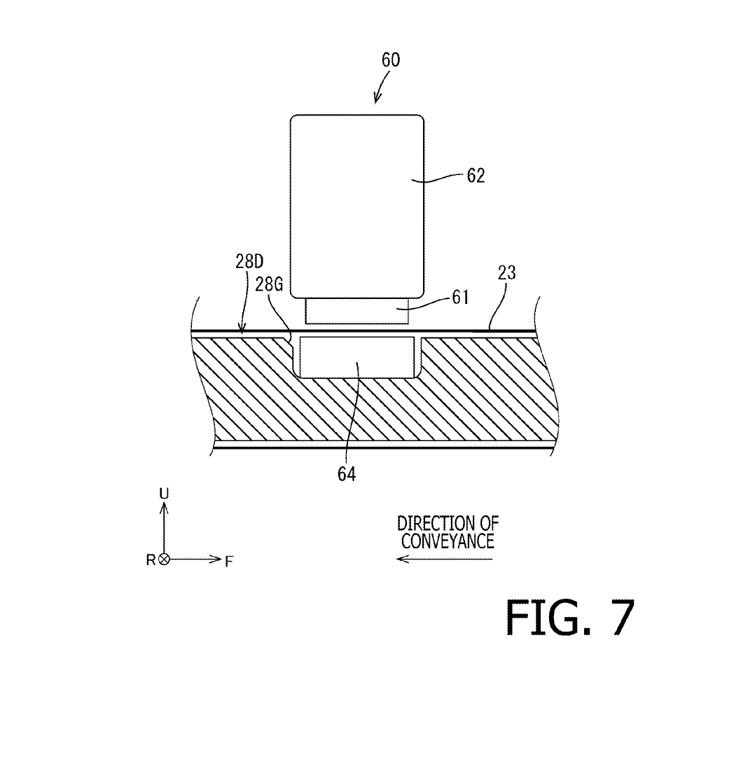

As shown in FIG. 7, according to the exemplary embodiment, while the ribs 28D are arranged in the positions displaced from the head portion 61 along the direction of conveyance, the ribs 28D are also arranged in positions to coincide with the head portion 61 along the direction of conveyance at the same time. In this regard, the arrangement that the ribs 28D coincide with the head portion 61 along the direction of conveyance refers to a condition that the ribs 28D and the head portion 61 fall on a same area with regard to the direction of conveyance. In other words, the ribs 28D overlap the head portion 61 in a view along the direction orthogonal to the direction of rotation axis. Therefore, the ribs 28D are extended throughout the positions on and off the head portion 61 along the direction of conveyance. In the meantime, the ribs 28D coincident with the head portion 61 are formed to be lower with regard to the direction of gravity than the ribs 28D at the positions displaced from the head portion 61.

In the positions to coincide with the head portion 61 along the direction of conveyance, where the ribs 28D are formed to be lower, arranged are the ink absorbers 64 on top of the ribs 28D with regard to the direction of gravity. Thus, the ink absorbers 64 may prevent the ink discharged out of the nozzles 63 of the head portion 61 from adhering to the ribs 28D.

The ink absorbers 64 are in positions substantially lower than the belt 23 with regard to the direction of gravity. The ribs 28D in the positions to coincide with the head portion 61 are formed to be lower at the areas to overlap the head portion 61 than the other areas for a thickness of the ink absorbers 64. Therefore, the ink absorbers 64 arranged on top of the ribs 28D with regard to the direction of gravity may align at the substantially same level as the upper edges of the ribs 28D in the other areas.

According to the exemplary embodiment described above, the ink absorbers 64 are arranged on a lower side opposite from the upper outer surface of the belt 23 with regard to the direction of gravity. The ink absorbers 64 are arranged in the overlapping area G1 and in the exposed areas G2, in which the ink absorbers 64 coincide with the head portion 61. While the ink absorbers 64 are arranged in the exposed areas G2 to coincide with the head portion 61, the ink which was discharged out of the inkjet head 60 but did not land on the sheet W or the belt 23 may be absorbed by the ink absorbers 64.

According to the exemplary embodiment described above, the ribs 28D are arranged to extend along the direction of conveyance indistinctively through the positions displaced from the head portion 61 and the positions to coincide with the head portion 61. Therefore, compared to a configuration, in which the ribs 28D are not arranged in the positions to coincide with the head portion 61, rigidity of the frame 28 may be improved.

According to the exemplary embodiment described above, in the positions along the direction of conveyance to coincide with the head portion 61, arranged are the ink absorbers 64 on the upper side of the ribs 28D with regard to the direction of gravity. Thereby, the ribs 28 may be prevented from being stained by the ink discharged from the inkjet head 60.

According to the exemplary embodiment described above, the ink absorbers 64 are arranged to locate the tops thereof to align at the substantially same level as the displaced parts of the ribs 28D, which are displaced from the head portion 61 along the direction of conveyance. Therefore, when the sheet W is conveyed to the position to coincide with the head portion 61, a distance between the inkjet head 60 and the sheet W in the overlapping area G1 along the direction of gravity and a distance between the inkjet head 60 and the sheet 60 in the exposed areas G2 along the direction of gravity may be substantially constant throughout the range along the direction of rotation axis. Thus, the belt 23 having the width Wb, which is smaller than the image forming area GR along the direction of rotation axis, may be used in the color inkjet printer 1 having the line-typed inkjet head 60 without lowering the image-forming quality, which may otherwise be lowered due to the unevenness in the sheet W in the range along the direction of rotation axis.

Although examples of carrying out the disclosure have been described, those skilled in the art will appreciate that there are numerous variations and permutations of the image forming apparatus that fall within the spirit and scope of the disclosure as set forth in the appended claims. It is to be understood that the subject matter defined in the appended claims is not necessarily limited to the specific features or act described above. Rather, the specific features and acts described above are disclosed as example forms of implementing the claims.

For example, the image forming apparatus may not necessarily be limited to the multicolor image forming apparatus but may be a monochrome image forming apparatus.

For another example, the support roller 21 and the driving roller 22 may not necessarily be the only rollers to strain the belt 23 around, but an additional roller to strain the belt 23 around may be provided in addition to the support roller 21 and the driving roller 22.

For another example, the ribs 28D may not necessarily be arranged to extend in parallel with one another along the direction of conveyance but may be, for example, in a delta arrangement such that a distance between adjoining ribs 28D may be widened as the ribs 28D extend downstream along the direction of conveyance.

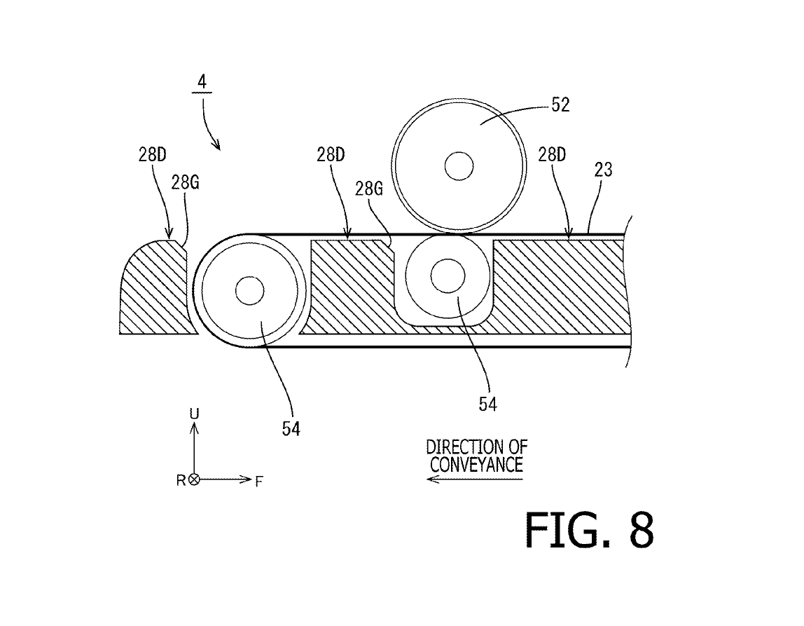

For another example, the ribs 28D may not necessarily be arranged to incline upward with regard to the direction of gravity but may be, for example, as shown in FIG. 8, arranged on a downstream side of the driving roller 54 with regard to the direction of conveyance so that the ribs 28D shift from the inner side of the belt 23 to the outer side of the belt 23 as the ribs 28D extend downstream away from the image forming area GR along the direction of conveyance.

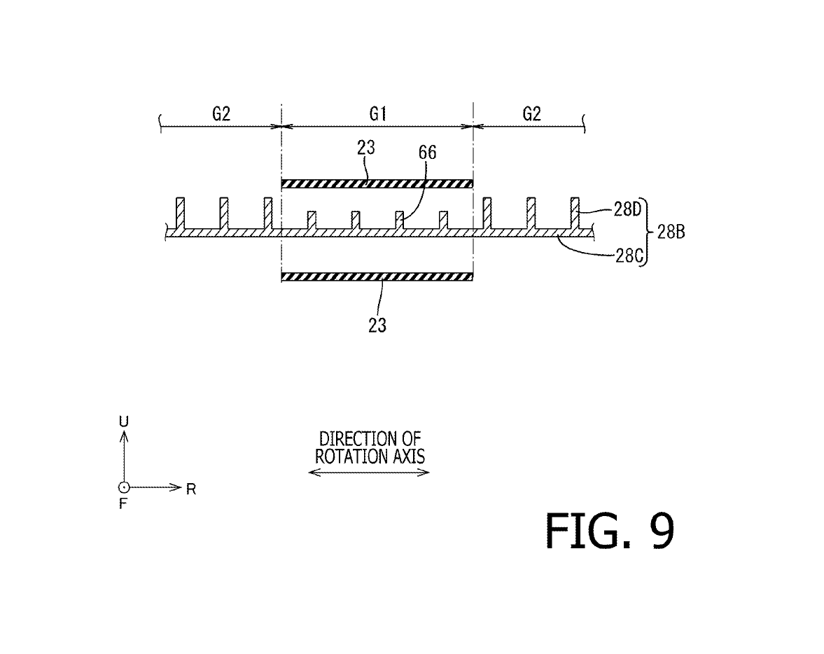

For another example, positions of the ribs 28D may not necessarily be limited in the exposed areas G2, but ribs 66 (see FIG. 9) may be arranged in the overlapping area G1. As shown in FIG. 9, the intermediate part 28D of the frame 28 provides the base plane 28C, which is arranged inside the belt 23. The base plane 28C spreads throughout the intermediate part 28D along the direction of rotation axis. The ribs 28D may be arranged in the exposed areas G2 to protrude upward with regard to the direction of gravity, and the ribs 66 may be arranged in the overlapping area G1 to protrude upward with regard to the direction of gravity.

The ribs 66 may be formed to be shorter than the ribs 28D with regard to the direction of gravity and may be arranged to be spaced apart from the belt 23 on the lower side of the belt 23 with regard to the direction of gravity. Thus, the ribs 66 formed in the overlapping area G1 may improve rigidity of the intermediate part 28B.

For another example, rotation of the rollers including the driving roller 22 and the registration roller 13 may not necessarily be controlled by the single CPU 71 but may be controlled by a plurality of CPUs, or may be controlled by a dedicated hardware circuit such as the ASIC 75 or by the CPU(s) and hardware circuits.

For another example, the belt 23 may not necessarily be arranged to locate the center thereof along the direction of rotation axis to align with the center of the transfer roller 54 along the direction of rotation axis. For example, the belt 23 may be arranged to locate a leftward end thereof to align with a leftward end of the transfer roller 54. For another example, the belt 23 may not necessarily be a single piece of belt 23 but may include a plurality of pieces of belts 23.

What is claimed is:

1. An image forming apparatus, comprising:
a conveyer configured to convey a sheet, comprising:
a first roller;
a second roller; and
a belt strained around the first roller and the second roller and comprising a first surface configured to contact the sheet;
an image forming unit configured to form an image on the sheet being conveyed in an image forming area, the image forming area comprising at least a part of an overlapping area and at least a part of a displaced area, the overlapping area being coincident with the belt, and the displaced area being displaced from the belt along a direction of rotation axis of the first roller; and
a guide member configured to guide a surface of the sheet, the guide member being arranged in a position displaced from the belt along the direction of rotation axis and at least in a position displaced from the image forming area along a direction of conveyance to convey the sheet by the conveyer.

2. The image forming apparatus according to claim 1,
wherein the guide member comprises a rib extending along the direction of conveyance.

3. The image forming apparatus according to claim 2,
wherein the guide member comprises a base plane spreading in parallel with the first surface; and
wherein the rib protrudes from the base plane.

4. The image forming apparatus according to claim 1,
wherein the guide member is arranged on a side of a second surface of the belt being a reverse surface of the first surface.

5. The image forming apparatus according to claim 1,
wherein the image forming unit comprises:
a photosensitive member arranged on a side of the first surface, the photosensitive member being configured to carry an image formed in a developer agent; and
a transfer member arranged on a side of a second surface of the belt being a reverse surface of the first surface, the transfer member being configured to transfer the image formed in the developer agent to the sheet in the image forming area.

6. The image forming apparatus according to claim 4,
wherein the guide member is arranged on an upstream side of the transfer member with regard to the direction of conveyance.

7. The image forming apparatus according to claim 4,
wherein the guide member is arranged on a downstream side of the transfer member with regard to the direction of conveyance.

8. The image forming apparatus according to claim 7,
wherein the guide member is arranged on the side of the second surface; and
wherein the guide member arranged on the downstream side of the transfer member with regard to the direction of conveyance is formed to have a beveled edge in an adjoining part adjoining the transfer member, the beveled edge inclining to shift closer to the side of the first surface as the guide member extends away from the transfer member.

9. The image forming apparatus according to claim 8,
wherein the photosensitive member and the transfer member in the image forming unit comprise a plurality of photosensitive members and a plurality of transfer members respectively; and
wherein the guide member is arranged in an intermediate position between the plurality of transfer members along the direction of conveyance.

10. The image forming apparatus according to claim 8,
wherein the guide member is arranged in a position on a same side as the transfer member with respect to a contact position between the photosensitive member and the transfer member and in a position farther from the photosensitive member than the contact position with regard to an orthogonal direction being orthogonal to the first surface.

11. The image forming apparatus according to claim 10,
wherein the guide member is arranged to be closer to the photosensitive member than a rotation axis of the photosensitive member with regard to the orthogonal direction.

12. The image forming apparatus according to claim 1,
wherein the image forming unit comprises an inkjet head configured to discharge ink from a nozzle.

13. The image forming apparatus according to claim 12,
wherein the nozzle of the inkjet head comprises a plurality of nozzles arranged in an entire range along the direction of rotation axis in the image forming area.

14. The image forming apparatus according to claim 13, further comprising:
an ink absorber arranged on a side of a second surface of the belt being a reverse surface of the first surface, the ink absorber being arranged in a position displaced from the belt along the direction of rotation axis and in a position to coincide with the inkjet head.

15. The image forming apparatus according to claim 14,
wherein the guide member is arranged in a position to coincide with the image forming area along the direction of conveyance; and
wherein the guide member in the position to coincide with the inkjet head is arranged on the side of the second surface in a position closer to the second surface than the ink absorber with regard to an orthogonal direction being orthogonal to the first surface of the belt.

16. The image forming apparatus according to claim 1,
wherein a part of the guide member is arranged on a side of a second surface of the belt being a reverse surface of the first surface; and
wherein the guide member shifts from the side of the second surface to the side of the first surface as the guide member extends downstream away from the image forming area along the direction of conveyance.
